(19) United States
(12) Patent Application Publication
(10) Pub. No.: US 2005/0286683 A1
(43) Pub. Date: Dec. 29, 2005

(54) System for rapidly identifying body parts by matching optical and radiographic images

(76) Inventor: Gary R. Cantu, San Carlos, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/888,571

(22) Filed: Jul. 9, 2004

Related U.S. Application Data
(60) Provisional application No. 60/582,787, filed on Jun. 24, 2004.

(51) Int. Cl. H05G 1/64

(52) U.S. Cl. 378/98.12

(57) ABSTRACT

A system for matching optical and radiographic images, including: a digital radiography beam emitter; and an optical camera connected to the digital radiography beam emitter; wherein a digital radiographic image is recorded concurrently with a image from the optical camera.

### RELATED APPLICATION

This application claims priority under 35 U.S.C. § 119 to U.S. Provisional Application No. 60/582,787 entitled System for Matching Optical and Radiographic Images and filed on Jun. 24, 2004.

### TECHNICAL FIELD

The present invention relates to radiography and X-ray imaging in the veterinary and medical fields.

### BACKGROUND OF THE INVENTION

It is often difficult for an operator of a digital radiography system to quickly distinguish between radiographic images so as to determine what body part a particular radiographic image matches.

This problem becomes more acute when the operator is reviewing large numbers of radiographic images. In addition, the problem of quickly matching radiographic images to body parts is further complicated in veterinary applications.

### SUMMARY OF THE INVENTION

The present invention provides a system for matching optical and radiographic images, using: a digital radiography beam emitter; and an optical camera connected to the digital radiography beam emitter; wherein a digital radiographic image is recorded concurrently with a image from the optical camera.

The present invention also provides a system for matching radiographic images to body parts, including: a digital radiography beam emitter; and an optical camera, wherein both the digital radiography beam emitter and the optical camera are positioned to image the body part from the same direction.

In preferred embodiments, the digital radiography beam emitter is handheld, and the optical camera is mounted onto the digital radiography beam emitter.

The digital radiography beam emitter and the optical camera are configured to simultaneously image the body part from the same direction. A beam splitter may be used such that the optical image recorded by the camera is taken co-linearly with the radiographic beam emitted by the beam emitter. A computer is used to store radiographic images taken by the digital radiography beam emitter and optical images taken by the camera. A computer screen is used to display the radiographic and optical images.

In one embodiment of the invention, the operator matches the radiographic image to the body part (by viewing the optical and radiographic images). In another embodiment of the invention, the computer matches the radiographic image to the body part.

Te present invention also provides a method of matching radiographic images to body parts, by: taking a digital radiographic image of a body part with a digital radiography beam emitter; taking an optical image of the body part with a camera; and determining the identity of the body part by matching the radiographic image with the optical image. The radiographic image and the optical image are preferably taken at the same time, and from the same point in space.

### BRIEF DESCRIPTION OF THE DRAWINGS:

FIG. 1 is a perspective view of the present invention in operation.

FIG. 2 is a top schematic view corresponding to FIG. 1.

### DETAILED DESCRIPTION OF THE DRAWINGS

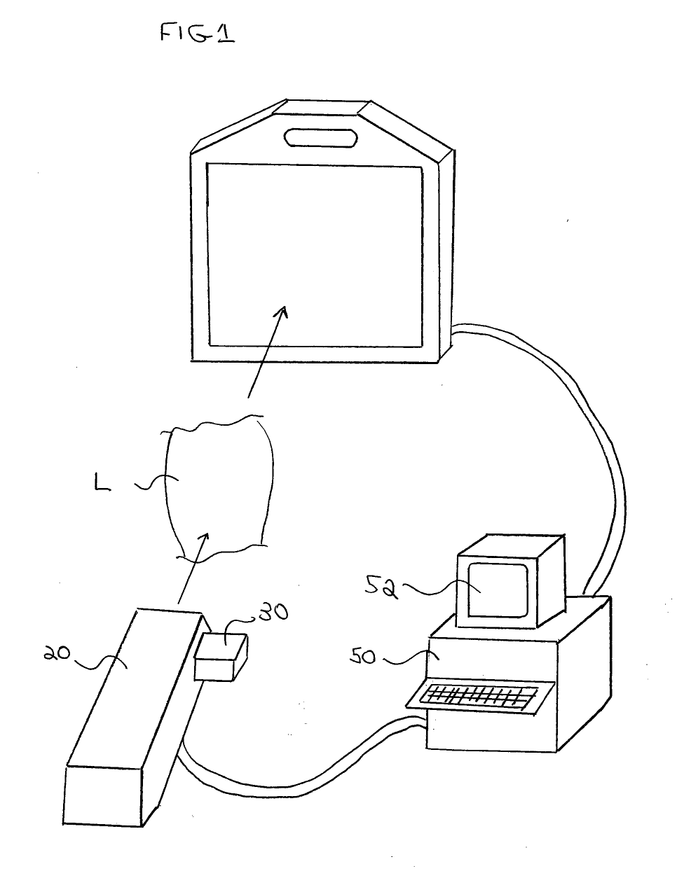

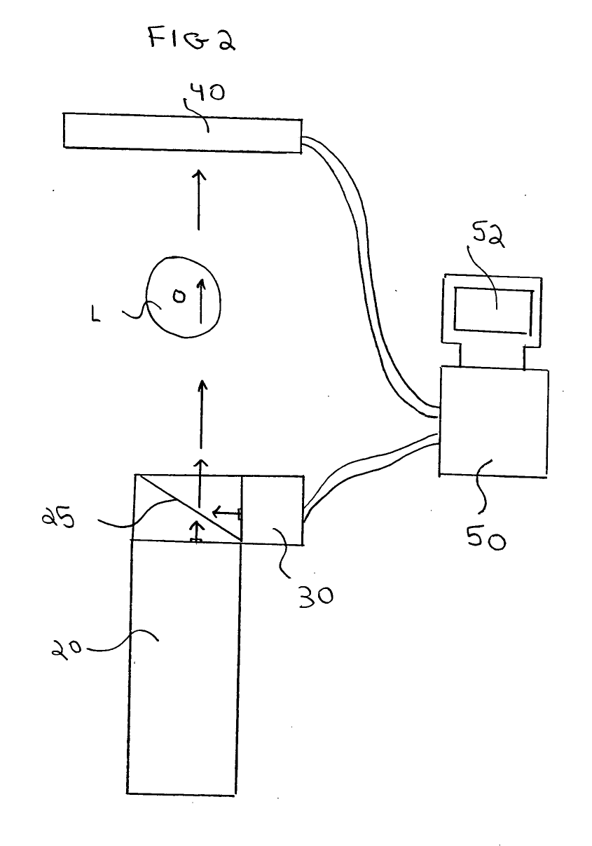

As illustrated in FIGS. 1 and 2, the present invention provides a system 10 for matching radiographic images to body parts by matching corresponding optical and radiographic images of the body part in question.

System 10 includes a digital radiography beam emitter 20, and an optical camera 30. Camera 30 is preferably a digital camera mounted directly onto digital radiography beam emitter 20, as shown. Digital radiography beam emitter 20 is preferably handheld, but need not be so.

A body part (e.g.: leg L of a horse) is placed between digital radiography beam emitter 20/optical camera 30 and a radiography sensor pad 40, as shown. Radiography beam emitter 20 and optical camera 30 are preferably activated to image the body part simultaneously, or near simultaneously. As a result, radiography beam emitter 20 sends an X-ray beam through leg L, creating a radiographic image that is received by radiography sensor pad 40 at (or approximately) the same time that camera 30 takes a picture of leg L.

The radiographic image that is received by radiography sensor pad 40 is stored in computer 50. In addition, the optical image taken by camera 30 is also stored in computer 50. Computer 50 is configured such that the two optical and radiographic images are linked together. As a result, when an operator views any particular stored radiographic image, (s)he is able to call up and view the corresponding optical image. By viewing the particular optical image linked to a particular radiographic image, the operator is therefore easily able to view and identify the body part that corresponds to the radiographic image. This is because it is easier for an operator to recognize an optical image of a body part than a radiographic image of the body part.

In preferred embodiments, the digital radiographic image taken by beam emitter 40 is recorded concurrently with a image taken by optical camera 30. It is to be understood that taking radiographic and optical images simultaneously is preferred. However, a short interval of time between the taking of the radiographic and optical images is permitted. In accordance with the present invention, what is desired is only that the optical image assists an operator in recognizing which body part corresponds to a radiographic image. It is not necessary that the radiographic and optical images are taken simultaneously. However, it is desirable that these images be taken simultaneously in those embodiments where the beam emitter 20/camera 30 assembly is hand-held. In optional embodiments, radiography sensor pad 40 may also be handheld as well.

In one embodiment, shown in FIG. 2, a beam splitter 25 is positioned such that the optical image recorded by camera 30 is taken co-linearly with the radiographic beam emitted by beam emitter 20. As a result, both beam emitter 20 and optical camera 30 are positioned to image the body part from the same direction (and from the same point in space).

Computer 50 preferably includes a display screen 52 that is configured to display the radiographic and optical images. The images may optionally be displayed simultaneously. For example, the images may optionally be displayed side-by-side; or, the images may optionally be displayed overlayed one on top of one another.

In one embodiment of the invention, the operator matches a radiographic image to a body part by viewing the corresponding optical image on screen 52.

In an alternate embodiment of the invention, computer 50 itself matches a radiographic image to a body part by identifying optical images and then matching stored radiographic and optical images.

The present invention also includes method of matching radiographic images to body parts, by: taking a digital radiographic image of a body part (e.g.: leg L) with a digital radiography beam emitter 20; taking an optical image of the body part (e.g.: leg L) with camera 30; and then determining the identity of the body part (e.g.: leg L) by matching corresponding radiographic and optical images of the body part (e.g.: leg L).

The present invention thus provides a system for matching optical and radiographic images such that there is no confusion when viewing a radiographic image as to which angle the image was taken from.

Specifically, the present invention integrates a standard camera with the radiography beam emitter (ie: an X-ray type of gun). As such, when the digital radiography beam emitter takes an image (i.e.: when the X-ray image is taken with the emitter gun facing the target area of the patient (with the digital radiography sensor pad positioned therebehind), the camera, which is preferably mounted onto or otherwise incorporated into the beam emitter concurrently takes an optical picture of the region of the patient which is being digitally radiographed.

Preferably, the standard optical image (i.e.: the normal visual light picture) is taken at the same time as the digital radiographic image. Both images are preferably stored together. Thus, should the operator have any confusion at to what portion of tissue the digital radiographic image is showing, the operator need only call up the visual light picture image taken at the same time. This greatly facilitates the operator being able to distinguish between radiographic images. For example, in the case of a horse, the operator can easily view the visual light picture and thus clearly recognize which leg of the horse was digitally radiographed.

1. A system for matching optical and radiographic images, comprising:
a digital radiography beam emitter; and
an optical camera connected to the digital radiography beam emitter; wherein a digital radiographic image is recorded concurrently with a image from the optical camera.

2. The system of claim 1, further comprising:
a beam splitter positioned such that the optical image recorded by the camera is taken co-linearly with the radiographic beam emitted by the beam emitter.

3. The system of claim 1, wherein the digital radiography beam emitter is handheld, and wherein the optical camera is mounted onto the digital radiography beam emitter.

4. The system of claim 1, further comprising:
a computer configured to store radiographic images taken by the digital radiography beam emitter and optical images taken by the camera.

5. The system of claim 4, further comprising:
a computer screen configured to simultaneously display the radiographic and optical images.

6. The system of claim 4, wherein the computer screen is configured to simultaneously display the radiographic and optical images side-by-side.

7. The system of claim 4, wherein the computer screen is configured to simultaneously display the radiographic and optical images overlayed one another.

8. The system of claim 1, wherein the optical camera is a digital optical camera.

9. The system of claim 1, further comprising:
a radiography sensor pad positioned to receive a radiography beam from a digital radiography beam emitter.

10. The system of claim 9, wherein the radiography sensor pad is handheld.

11. A system for matching radiographic images to body parts, comprising:
a digital radiography beam emitter; and
an optical camera, wherein both the digital radiography beam emitter and the optical camera are positioned to image the body part from the same direction.

12. The system of claim 11, wherein the optical camera is mounted onto the digital radiography beam emitter.

13. The system of claim 11, further comprising:
a beam splitter positioned such that the optical image recorded by the camera is taken co-linearly with the radiographic beam emitted by the beam emitter.

14. The system of claim 11, wherein the digital radiography beam emitter and the optical camera are configured to simultaneously image the body part.

15. The system of claim 11, wherein the digital radiography beam emitter is handheld, and wherein the optical camera is mounted onto the digital radiography beam emitter.

16. The system of claim 11, further comprising:
a computer configured to store radiographic images taken by the digital radiography beam emitter and optical images taken by the camera.

17. The system of claim 16, further comprising:
a computer screen configured to simultaneously display the radiographic and optical images.

18. The system of claim 16, wherein the computer screen is configured to simultaneously display the radiographic and optical images side-by-side.

19. The system of claim 16, wherein the computer screen is configured to simultaneously display the radiographic and optical images overlayed one another.

20. The system of claim 11, wherein the optical camera is a digital optical camera.

21. The system of claim 11, further comprising:
a radiography sensor pad positioned to receive a radiography beam from a digital radiography beam emitter.

22. The system of claim 21, wherein the radiography sensor pad is handheld.

23. A method of matching radiographic images to body parts, comprising:
taking a digital radiographic image of a body part with a digital radiography beam emitter;
taking an optical image of the body part with a camera; and
determining the identity of the body part by matching the radiographic image with the optical image.

24. The method of claim 23, wherein the radiographic image and the optical image are taken at the same time.

25. The method of claim 23, wherein the radiographic image and the optical image are taken from the same point in space.

26. The method of claim 23, wherein the radiographic image and the optical image are taken co-linearly.

27. The method of claim 23, further comprising:
storing the radiographic image and the optical image in a computer.

28. The method of claim 27, further comprising:
displaying the radiographic image and the optical image to an operator.

29. The method of claim 28, wherein displaying the radiographic image and the optical image comprises:
displaying the radiographic image and the optical image side by side on a computer screen.

30. The method of claim 29, wherein displaying the radiographic image and the optical image comprises:
displaying the radiographic image and the optical image overlayed one another on a computer screen.

31. The method of claim 23, wherein an operator determines the identity of the body part by matching the radiographic image with the optical image.

32. The method of claim 23, wherein a computer determines the identity of the body part by matching the radiographic image with the optical image.
